(19) United States
(12) Patent Application Publication
(10) Pub. No.: US 2006/0060792 A1
(43) Pub. Date: Mar. 23, 2006

(54) Radiographic image conversion panel and method of manufacturing the same

(75) Inventors: Hiroshi Matsumoto, Kanagawa (JP); Hirokazu Misawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/231,862

(22) Filed: Sep. 22, 2005

(30) Foreign Application Priority Data
Sep. 22, 2004 (JP) 2004-275295

(51) Int. Cl. G01N 21/64

(52) U.S. Cl. 250/483.1

(57) ABSTRACT

There is provided a radiographic image conversion panel having a substrate made of a metal or an alloy, an oxide layer formed on the substrate by a vapor deposition technique such as sputtering, ion plating or ion beam assisted deposition, and a phosphor layer formed on the oxide layer by the vapor deposition technique. A method of manufacturing the radiographic image conversion panel is also provided. The radiographic image conversion panel is capable of suppressing for a long time corrosion of the surface of the substrate due to a reaction between a stimulable phosphor and the substrate through moisture and also capable of providing a radiographic image without any deterioration of the characteristics.

The entire contents of literatures cited in this specification are incorporated herein by reference.

### BACKGROUND OF THE INVENTION

The present invention relates to a radiographic image conversion panel in which a stimulable phosphor layer is used to record and reproduce a radiographic image and a method of manufacturing the same. More specifically, the present invention relates to a radiographic image conversion panel which is capable of suppressing corrosion of a substrate due to moisture absorption by the stimulable phosphor layer and has no deterioration of characteristics and a method of manufacturing the same.

There are known a class of phosphors which accumulate a portion of applied radiations (e.g. x-rays, α-rays, β-rays, γ-rays, electron beams, and uv (ultraviolet) radiation) and which, upon stimulation by exciting light such as visible light, give off a burst of light emission in proportion to the accumulated energy. Such phosphors called stimulable phosphors are employed in medical and various other applications.

An exemplary application is a radiographic image information recording and reproducing system which employs a radiographic image conversion panel having a film formed of the stimulable phosphor (stimulable phosphor layer). This radiographic image information recording and reproducing system has already been commercialized as FCR (Fuji Computed Radiography) from Fuji Photo Film Co., Ltd.

In that system, a subject such as a human body is irradiated with x-rays or the like to record radiographic image information about the subject on the radiographic image conversion panel (more specifically, on the stimulable phosphor layer). After the radiographic image information is thus recorded, the radiographic image conversion panel is scanned two-dimensionally with exciting light such as laser light to produce stimulated emission which, in turn, is read photoelectrically to yield an image signal. Then, an image reproduced on the basis of the read image signal is output as the radiographic image of the subject, typically to a display device such as CRT or on a recording material such as a photographic material.

The radiographic image conversion panel is typically produced by the steps of first preparing a coating solution having the particles of a stimulable phosphor dispersed in a solvent containing a binder, etc., applying the coating solution to a support in panel form that is made of glass or resin, and drying the applied coating.

Phosphor panels are also known that are made by forming a stimulable phosphor layer (hereinafter also referred to as a phosphor layer) on a support through methods of vacuum film deposition (vapor deposition) such as vacuum evaporation or sputtering. The phosphor layer prepared by the vacuum film deposition has excellent characteristics. First, it contains less impurities since it is formed under vacuum; further, it is substantially free of any substances other than the stimulable phosphor, as exemplified by the binder, so it has high uniformity in performance and still assures very high luminous efficiency. In addition, the phosphor layer is formed of a phosphor having a columnar structure and hence high sharpness and excellent image quality are achieved.

However, the radiographic image conversion panel has a problem that the stimulable phosphor layer has high moisture absorption.

The stimulable phosphor layer, in particular, the alkali halide-based stimulable phosphor layer having favorable characteristics, has high moisture absorption and easily absorbs moisture even in an ambient environment (ambient temperature/ambient humidity). As a result, deterioration of sharpness of a reproduced image or the like occurs due to deterioration of photostimulated luminescence characteristics, that is, sensitivity, or deterioration of crystallinity of the stimulable phosphor (destruction of columnar crystals in the case of the alkali halide-based stimulable phosphor having a columnar structure, for example). In order to prevent such a situation, the stimulable phosphor layer of the radiographic image conversion panel is sealed with a moisture-proof member.

A substrate made of a metal or an alloy can also be used for the support in the radiographic image conversion panel. In this case, even if the stimulable phosphor layer is sealed with a moisture-proof member, the moisture absorption by the stimulable phosphor layer cannot be completely prevented and the reaction through moisture between the stimulable phosphor and the metal substrate causes substrate corrosion. Therefore, a layer is formed between the substrate and the stimulable phosphor layer to prevent the substrate from being brought into direct contact with the stimulable phosphor layer (see WO 2002/086540 and JP 04-118599 A).

In WO 2002/086540, there is disclosed a radiographic image conversion panel in which moisture-impermeable layers are formed on the front and rear sides of a substrate and a stimulable phosphor layer is then formed on the moisture-impermeable layer formed on the front side of the substrate.

Examples of the moisture-impermeable layer of the radiographic image conversion panel disclosed in WO 2002/086540 include a metal oxide layer, an anodic oxide layer and a polyimide layer.

JP 04-118599 A discloses an X-ray image conversion sheet using a stimulable phosphor. For attaining desired image characteristics such as resolution, the X-ray image conversion sheet in JP 04-118599 A has a white oxide film placed between a stimulable phosphor layer and a support made of aluminum. Alumina is used as the oxide.

In the radiographic image conversion panel disclosed in WO 2002/086540, however, the metal oxide layer, the anodic oxide layer and the polyimide layer are illustrated for the moisture-impermeable layer but no specific method of manufacturing the other layers than the anodic oxide layer is found. As disclosed in WO 2002/086540, it is difficult to obtain a uniform film having a sufficiently large thickness for the moisture-impermeable layer by simply forming any of the metal oxide layer, anodic oxide layer or polyimide layer as the moisture-impermeable layer. Therefore, the moisture-impermeability of the resulting layer will lack in uniformity or the surface of a stimulable phosphor layer formed on the moisture-impermeable layer will cause undulating or the like, which may affect the uniformity in the film thickness of the phosphor layer. Consequently, there is a problem in that the desired image characteristics such as resolution cannot be obtained.

Furthermore, in each of WO 2002/086540 and JP 04-118599 A, the formation of an anodic oxide film may cause an increase in minute surface roughness due to the porous structure of the anodic oxide film. Therefore, there is a problem in that the columnar structure of a stimulable phosphor layer formed on the anodic oxide film will deteriorate and hillocks (point defect) will be formed therein, and the image characteristics finally obtained will deteriorate owing to the above defects.

### SUMMARY OF THE INVENTION

The present invention intends to solve the conventional problem described above and to provide a radiographic image conversion panel which is capable of suppressing for a long time corrosion of the surface of a metal substrate due to a reaction between a stimulable phosphor and the metal substrate through moisture and also capable of providing a radiographic image without any deterioration of the characteristics, and also provide a method of manufacturing the radiographic image conversion panel.

In order to achieve the above object, according to a first aspect of the present invention, there is provided a radiographic image conversion panel having a substrate made of a metal or an alloy, an oxide layer formed on the substrate by a vapor deposition technique, and a phosphor layer formed on the oxide layer by the vapor deposition technique.

In the present invention, the oxide layer is preferably formed by sputtering, ion plating or ion beam assisted deposition.

In the present invention, the oxide layer is preferably made of SiO₂, Al₂O₃, or TiO₂.

Furthermore, in the present invention, the oxide layer has preferably a thickness of 0.5 μm or more.

Still furthermore, in the present invention, a surface of the substrate preferably has an arithmetic mean roughness Rₐ of 0.005 to 0.1 μm.

Furthermore, in the present invention, a surface of the substrate preferably has a maximum height R_{y} of 0.005 to 1 μm.

According to the present invention, the substrate is preferably made of aluminum.

In addition, in the present invention, the phosphor layer is preferably made of CsBr:Eu.

According to a second aspect of the present invention, there is also provided a method of manufacturing a radiographic image conversion panel, including the steps of: forming an oxide layer on a substrate made of a metal or an alloy by a vapor deposition technique; and forming a phosphor layer on the oxide layer by the vapor deposition technique.

According to the radiographic image conversion panel in the first aspect of the present invention, the oxide layer is formed on the substrate made of a metal or an alloy by using the vapor deposition technique and hence is smooth and compact, is highly uniform in thickness, and has no defect such as pin holes. Therefore, the substrate made of a metal or an alloy can be prevented for a long time from being corroded by a reaction with the stimulable phosphor through moisture even under severe conditions such as high temperature and high humidity, which allows a radiographic image to retain its characteristics for a long time without any deterioration.

In addition, the oxide layer in the present invention is smooth and compact, and is highly uniform in thickness, and hence abnormal growth of the stimulable phosphor layer formed on the oxide layer (occurrence of hillocks) can be prevented and a radiographic image which can be finally obtained has no point defects such as dead pixels.

Furthermore, according to the method of manufacturing a radiographic image conversion panel in the second aspect of the present invention, an oxide layer can be formed on a substrate made of a metal or an alloy by a vapor deposition technique, thereby obtaining the oxide layer which is smooth and compact, is highly uniform in thickness, and has no defect such as pin holes. Therefore, the substrate made of a metal or an alloy can be prevented for a long time from being corroded by a reaction with the stimulable phosphor through moisture even under severe conditions such as high temperature and high humidity, which allows a radiographic image to retain its characteristics for a long time without any deterioration.

In addition, since the oxide layer in the present invention is smooth and compact, is highly uniform in thickness, and has no point defects such as pin holes, abnormal growth of the stimulable phosphor layer formed on the oxide layer (occurrence of hillocks) can be prevented and a radiographic image which can be finally obtained has no point defects such as dead pixels.

### BRIEF DESCRIPTION OF THE DRAWINGS

In the accompanying drawings:

FIG. 1 is a schematic cross-sectional view showing a radiographic image conversion panel according to an embodiment of the present invention;

FIG. 2 is a plan view schematically showing the configuration of a vacuum evaporation apparatus used for preparing radiographic image conversion panels in Examples of the present invention; and

FIG. 3 is a schematic cross-sectional view of a radiographic image conversion panel (i.e., reference panel) employed in Examples of the present invention.

### DETAILED DESCRIPTION OF THE INVENTION

The radiographic image conversion panel and the method of manufacturing the same according to the present invention will hereinafter be described in detail on the basis of a preferred embodiment shown in the accompanying drawings.

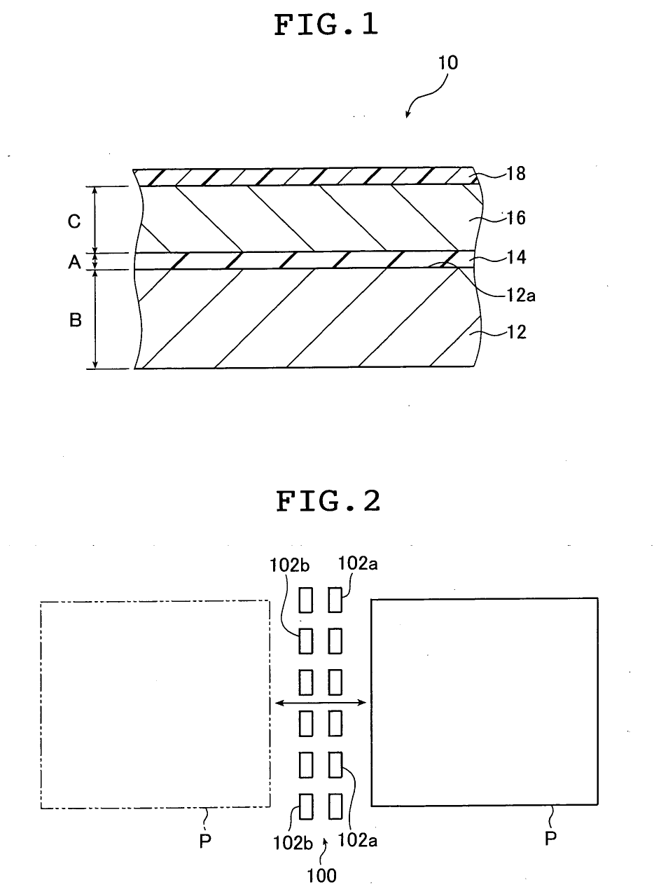

FIG. 1 is a schematic cross-sectional view showing a radiographic image conversion panel according to an embodiment of the present invention.

As shown in FIG. 1, a radiographic image conversion panel (hereinafter also referred to as a “phosphor panel”) 10 includes a substrate 12, an oxide layer 14 formed on a surface 12a of the substrate 12, a stimulable phosphor layer (hereinafter simply referred to as a “phosphor layer”) 16 formed on the oxide layer 14, and a moisture-proof protective layer 18 formed on the phosphor layer 16.

The substrate 12 in the phosphor panel 10 is for example a thin plate member or a sheet member. The substrate 12 is made of a metal or an alloy. In the present invention, the substrate 12 has no particular limitation, as long as it is made of a metal or an alloy. For example, the substrate 12 may be made of aluminum, an aluminum alloy, iron, a stainless steel, copper, chromium or nickel. In this embodiment, the substrate 12 is preferably made of aluminum or an aluminum alloy.

The substrate 12 preferably fulfills at least one of the following two conditions: One is that the arithmetic mean roughness Rₐ (JIS B 0601-1994) of the surface 12a is 0.005 to 0.1 μm and the other is that the maximum height R_{z} (JIS B 0601-2001) of the surface 12a is 0.005 to 1 μm.

If the substrate 12 fulfills at least one of the two conditions, the oxide layer 14 formed on the surface 12a by the vapor deposition technique is highly uniform in thickness and has no defects such as pin holes and abnormal growth of the phosphor layer 16 formed on the oxide layer 14 (occurrence of hillocks) can be further suppressed. The phosphor layer 16 having an excellent columnar structure can be also obtained. A higher quality radiographic image is thus obtained with the phosphor panel 10.

The oxide layer 14 suppresses the corrosion of the substrate 12 due to the moisture absorbed by the phosphor layer 16 and is formed by the vapor deposition technique. The oxide layer 14 has no particular limitation as long as it is formed by the vapor deposition technique. The oxide layer 14 can be made of, for example, SiO₂, Al₂O₃ or TiO₂.

The method applied to the vapor deposition technique for forming the oxide layer 14 is not limited in any particular way, as long as a smooth and compact moisture-impermeable film which is highly uniform in thickness and has no pin holes or other defects can be formed. Various techniques such as physical vapor deposition (PVD) or chemical vapor deposition (CVD) can be used. In this embodiment, sputtering, ion plating or ion beam assisted deposition is preferably used for the vapor deposition to form the oxide layer 14, because particles (molecules) deposited by sputtering, ion plating or ion beam assisted deposition have high energy and hence a particularly smooth and compact moisture-impermeable film which is highly uniform in thickness can be obtained compared to other vapor deposition techniques.

The ion beam assisted deposition in this embodiment uses an apparatus configured such that an evaporation source and an ion gun are mounted inside a film deposition (evaporation) chamber equipped with a plasma chamber and a substrate is placed so as to be opposed to the evaporation source. The ion beam assisted deposition is a special vacuum evaporation technique in which a film is formed on the surface of the substrate by depositing particles flying from the evaporation source onto the surface of the substrate while at the same time irradiating the surface of the substrate with plasma in the form of gas ions generated in the plasma chamber by means of the ion gun.

The oxide layer 14 has preferably a thickness A of not less than 0.5 μm, because if the thickness of the oxide layer 14 is not less than 0.5 μm, corrosion of the substrate 12 due to the reaction through moisture between the phosphor layer 16 and the substrate 12 is suppressed for a long time.

The upper limit of the thickness of the oxide layer 14 is 10 μm. If the thickness of the oxide layer 14 exceeds 10 μm, light scattering by the oxide layer 14 may be increased. The upper limit of the thickness of the oxide layer 14 varies with the material of the oxide layer 14 and the requisite image quality and is not limited to 10 μm in this embodiment.

When the phosphor layer 16 is irradiated with radiations (e.g. x-rays, α-rays, β-rays, γ-rays, electron beams, and uv radiation), the phosphor layer 16 accumulates a portion of radiation energy, and upon stimulation by exciting light such as visible light, gives off a burst of light emission in proportion to the accumulated energy.

Various materials can be used in the present invention for the stimulable phosphor constituting the phosphor layer 16. Preferred examples of the stimulable phosphor are given below.

Stimulable phosphors disclosed in U.S. Pat. No. 3,859,527 are “SrS:Ce, Sm”, “SrS:Eu, Sm”, “ThO₂:Er”, and “La₂O₂S:Eu, Sm”.

JP 55-12142 A discloses “ZnS:Cu, Pb”, “BaO.xAl₂O₃:Eu (0.8≦x≦10)”, and stimulable phosphors represented by the general formula “M^{II}O.xSiO₂:A”. In this formula, M^{II} is at least one element selected from the group consisting of Mg, Ca, Sr, Zn, Cd, and Ba, A is at least one element selected from the group consisting of Ce, Tb, Eu, Tm, Pb, Tl, Bi, and Mn, and 0.5≦x≦2.5.

Stimulable phosphors represented by the general formula “LnOX:xA” are disclosed by JP 55-12144 A. In this formula, Ln is at least one element selected from the group consisting of La, Y, Gd, and Lu, X is at least one element selected from Cl and Br, A is at least one element selected from Ce and Tb, and 0≦x≦0.1.

Stimulable phosphors represented by the general formula “(Ba₁₋ₓ, M²⁺ₓ)FX:yA” are disclosed by JP 55-12145 A. In this formula, M²⁺ is at least one element selected from the group consisting of Mg, Ca, Sr, Zn, and Cd, X is at least one element selected from Cl, Br, and I, A is at least one element selected from Eu, Tb, Ce, Tm, Dy, Pr, Ho, Nd, Yb, and Er, 0≦x≦0.6, and 0≦y≦0.2.

JP 59-38278 A discloses the stimulable phosphors represented by the general formula “xM₃(PO₄)₂.NX₂:yA” or “M₃(PO₄)₂.yA”. In this formula, M and N are each at least one element selected from the group consisting of Mg, Ca, Sr, Ba, Zn, and Cd, X is at least one element selected from F, Cl, Br, and I, A is at least one element selected from Eu, Tb, Ce, Tm, Dy, Pr, Ho, Nd, Yb, Er, Sb, Tl, Mn, and Sn, 0≦x≦6, and 0≦y≦1.

Stimulable phosphors are represented by the general formula “nReX₃.mAX′₂:xEu” or “nReX₃.mAX′₂:xEu, ySm”. In this formula, Re is at least one element selected from the group consisting of La, Gd, Y, and Lu, A is at least one element selected from Ba, Sr, and Ca, X and X′ are each at least one element selected from F, Cl, and Br, 1×10⁻⁴<x<3×10⁻¹, 1×10⁻⁴<y<1×10⁻¹, and 1×10⁻³<n/m<7×10⁻¹.

Alkali halide-based stimulable phosphors represented by the general formula “M^{I}X.aM^{II}X′₂.bM^{III}X″₃:cA” are disclosed by JP 61-72087 A. In this formula, M^{I} represents at least one element selected from the group consisting of Li, Na, K, Rb, and Cs. M^{II} represents at least one divalent metal selected from the group consisting of Be, Mg, Ca, Sr, Ba, Zn, Cd, Cu, and Ni. M^{III} represents at least one trivalent metal selected from the group consisting of Sc, Y, La, Ce, Pr, Nd, Pm, Sm, Eu, Gd, Tb, Dy, Ho, Er, Tm, Yb, Lu, Al, Ga, and In. X, X′, and X″ each represent at least one element selected from the group consisting of F, Cl, Br, and I. A represents at least one element selected from the group consisting of Eu, Tb, Ce, Tm, Dy, Pr, Ho, Nd, Yb, Er, Gd, Lu, Sm, Y, Tl, Na, Ag, Cu, Bi, and Mg, 0≦a<0.5, 0≦b<0.5, and 0<c≦0.2.

Stimulable phosphors represented by the general formula “(Ba₁₋ₓ, M^{II}ₓ)F₂.aBaX₂:yEu, zA” are disclosed by JP 56-116777 A. In this formula, M^{II} is at least one element selected from the group consisting of Be, Mg, Ca, Sr, Zn, and Cd, X is at least one element selected from Cl, Br, and I, A is at least one element selected from Zr and Sc, 0.5≦a≦1.25, 0≦x≦1, 1×10⁻⁶≦y≦2×10⁻¹ and 0<z≦1×10⁻².

Stimulable phosphors represented by the general formula “M^{III}OX:xCe” are disclosed by JP 58-69281 A. In this formula, M^{III} is at least one trivalent metal selected from the group consisting of Pr, Nd, Pm, Sm, Eu, Tb, Dy, Ho, Er, Tm, Yb, and Bi, X is at least one element selected from Cl and Br, and 0≦x≦0.1.

Stimulable phosphors represented by the general formula “Ba₁₋ₓMₐLₐFX:yEu²⁺” are disclosed by JP 58-206678 A. In this formula, M is at least one element selected from the group consisting of Li, Na, K, Rb, and Cs, L is at least one trivalent metal selected from the group consisting of Sc, Y, La, Ce, Pr, Nd, Pm, Sm, Gd, Tb, Dy, Ho, Er, Tm, Yb, Lu, Al, Ga, In, and Tl, X is at least one element selected from Cl, Br, and I, 1×10⁻²≦x≦0.5, 0≦y≦0.1, and a is x/2.

Stimulable phosphors represented by the general formula “M^{II}FX.aM^{I}X′.bM′^{II}X″₂.cM^{III}X₃.xA:yEu²⁺” are disclosed by JP 59-75200 A. In this formula, M^{II} is at least one element selected from the group consisting of Ba, Sr, and Ca, M^{I} is at least one element selected from Li, Na, K, Rb, and Cs, M′^{II} is at least one divalent metal selected from Be and Mg, M^{III} is at least one trivalent metal selected from the group consisting of Al, Ga, In, and Tl, A is a metal oxide, X, X′, and X″ are each one element selected from the group consisting of F, Cl, Br, and I, 0≦a≦2, 0≦b≦1×10⁻², 0≦c≦1×10⁻², and a+b+c≧10⁻⁶, 0<x≦0.5, and 0<y≦0.2.

Alkali halide-based stimulable phosphors disclosed by JP 59-38278 A are preferred because they have excellent photostimulated luminescence characteristics and the effect of the present invention is advantageously obtained. Alkali halide-based stimulable phosphors in which M^{I} contains at least Cs, X contains at least Br, and A is Eu or Bi are more preferred, and stimulable phosphors represented by the general formula “CsBr:Eu” are particularly preferred.

The phosphor layer 16 is formed of any of the stimulable phosphors described above by means of various vapor deposition techniques such as vacuum evaporation, sputtering and CVD. In addition, in the present invention, the phosphor layer 16 and the oxide layer 14 are manufactured by for example different film deposition apparatuses.

Of those, vacuum evaporation is preferably employed to form the phosphor layer 16 from the viewpoint of productivity or the like. It is particularly preferable to form the phosphor layer 16 by multi-source vacuum evaporation in which a material for a phosphor component and a material for an activator component are evaporated separately under heating. For example, the phosphor layer 16 of “CsBr:Eu” is preferably formed by multi-source vacuum evaporation in which cesium bromide (CsBr) as a material for the phosphor component and europium bromide (EuBrₓ (x is generally 2 to 3)) as a material for the activator component are evaporated separately under heating.

The heating method in vacuum evaporation is not particularly limited. The phosphor layer 16 may be formed by electron beam heating employing an electron gun or the like or through resistance heating. When the phosphor layer 16 is formed by multi-source vacuum evaporation, all materials may be evaporated under heating by the same heating means (such as electron beam heating). Alternatively, the material for the phosphor component may be evaporated under heating through electron beam heating, and the material for the activator component, which is in a trace amount, may be evaporated under heating through resistance heating.

There are no particularly limited conditions for film deposition under which the phosphor layer 16 must be formed, and the phosphor layer 16 may be formed under conditions for film deposition arbitrarily determined in accordance with the film deposition method or the composition or the like of the phosphor layer 16 to be formed. For example, the phosphor layer 16 is preferably formed through vacuum evaporation at a degree of vacuum of 1×10⁻⁵ Pa to 1×10⁻² Pa and a film deposition rate of 0.05 μm/min to 300 μm/min. When the phosphor layer 16 is formed through multi-source vacuum evaporation, evaporation rates of the materials for the phosphor component and the activator component are controlled such that the amount ratio of the phosphor component to the activator component falls within a desired range.

According to the studies conducted by the inventor of the present invention, when any of various stimulable phosphors as described above, in particular, an alkali halide-based stimulable phosphor such as CsBr:Eu is subjected to film deposition through vacuum evaporation, the phosphor layer 16 is preferably formed by evacuating a system to a high degree of vacuum once; introducing argon gas, nitrogen gas, or the like into the system to adjust to a medium degree of vacuum of about 0.01 Pa to 3 Pa; and carrying out vacuum evaporation through resistance heating under medium vacuum. The layer of the alkali halide-based phosphor such as CsBr:Eu has a columnar crystal structure, and the phosphor layer 16 obtained through film deposition under medium vacuum has a particularly favorable columnar crystal structure, and thus is preferable from the viewpoint of sharpness of an image with photostimulated luminescence characteristics.

The phosphor layer 16 formed may be heated at 300° C. or less during film deposition through heating of the substrate 12 or the like. The phosphor layer 16 is preferably heated at 200° C. or lower.

The thickness C of the phosphor layer 16 is also not particularly limited, but the phosphor layer 16 preferably has a thickness of 50 μm or more. The phosphor layer 16 particularly preferably has a thickness of 200 μm or more.

The thus formed phosphor layer 16 is subjected to a heat treatment (annealing) for imparting favorable photostimulated luminescence characteristics thereto and improving the photostimulated luminescence characteristics thereof.

The annealing condition for the phosphor layer 16 is not particularly limited. For example, the phosphor layer 16 is preferably annealed in an inert atmosphere such as a nitrogen atmosphere at 50° C. to 600° C. (particularly at 100° C. to 300° C.) for 10 minutes to 10 hours (particularly for 30 minutes to 3 hours).

The heat treatment for the phosphor layer 16 may be carried out through a known method such as a method employing a firing furnace. Further, if the vacuum evaporation apparatus includes a heating means for the substrate 12, the heat treatment can be carried out using the heating means.

The moisture-proof protective layer 18 is formed to cover and seal the phosphor layer 16 formed through vacuum evaporation thereby preventing moisture absorption by the phosphor layer 16. For example, thermal lamination is used to seal the phosphor layer 16 with the moisture-proof protective layer 18.

In the present invention, the moisture-proof protective layer 18 is not particularly limited as long as it has sufficient moisture-proof property, and various types can be used.

For example, the moisture-proof protective layer 18 is formed of 3 layers on a polyethylene terephthalate (PET) film: an SiO₂ film; a hybrid layer of SiO₂ and polyvinyl alcohol (PVA) and an SiO₂ film. Other preferable examples of the moisture-proof protective layer 18 include: a glass sheet (film); a film of resin such as polyethylene terephthalate or polycarbonate; and a film having an inorganic substance such as SiO₂, Al₂O₃, or SiC deposited on the resin film. For formation of the moisture-proof protective film 18 having 3 layers of SiO₂ film/hybrid layer of SiO₂ and PVA/SiO₂ film on the PET film, the SiO₂ films may be formed through sputtering and the hybrid layer may be formed through a sol-gel process, for example. The hybrid layer is preferably formed to have a ratio of PVA to SiO₂ of 1:1. The moisture-proof protective layer 18 has preferably a moisture vapor transmission rate of 0.2 to 0.6 g/m²·day under conditions of 40° C. and a relative humidity of 90%.

In this embodiment, the oxide layer 14 which is highly uniform in thickness and compact, and has a smooth surface is formed by the vapor deposition technique between the substrate 12 and the phosphor layer 16. As the oxide layer 14 is compact, there is no micropore or other defect as seen in the anodic oxide film. Thus, the moisture absorbed by the phosphor layer 16 can be prevented from permeate the substrate 12 through the oxide layer 14. Therefore, the substrate 12 can be prevented for a long time from being corroded by a chemical reaction between the phosphor layer 16 and the substrate 12 through moisture, thereby allowing the phosphor panel 10 to retain the characteristics of a radiographic image formed therein for a long time without any deterioration.

As the oxide layer 14 is highly uniform in thickness, has a smooth and compact structure and has no point defects such as pin holes, the phosphor layer 16 formed thereon can have an excellent columnar structure and is excellent in film quality without any point defect.

As described above, in the phosphor panel 10 of this embodiment, the phosphor layer 16 which is excellent in film quality and in which defects hardly occur can be formed. Thus, at the time of image recording or reproduction, a radiographic image which is free of point defects such as dead pixels and is excellent in image quality for a long time can be obtained.

By forming the moisture-proof protective layer 18 on the phosphor layer 16, the phosphor panel 10 of this embodiment can have excellent moisture resistance and prevent the phosphor layer 16 from absorbing moisture for a long time even under severe conditions such as high temperature and high humidity, and retain its good image-recording characteristics.

A stimulable phosphor forming the phosphor layer 16, particularly an alkali halide-based stimulable phosphor has moisture absorbing property and easily absorbs moisture even in a usual environment, and as a result the sensitivity or the sharpness of a reproduced image is decreased. Such an inconvenience can be thus avoided.

Hereinafter, a method of manufacturing the phosphor panel 10 of this embodiment will be described.

At first, the substrate 12 (see FIG. 1) made of a metal or an alloy is prepared. The substrate 12 is made of, for example, aluminum and has a thickness B of 1 mm.

Then, the surface 12a of the substrate 12 (see FIG. 1) is subjected to a vapor deposition such as sputtering or ion plating to form the oxide layer 14 (see FIG. 1) on the surface 12a. The oxide layer 14 is made of, for example, SiO₂, Al₂O₃, or TiO₂ and has a thickness A of 0.5 μm or more. The thickness A of the oxide layer 14 can be adjusted, for example, by controlling the film deposition rate.

Subsequently, the phosphor layer 16 (see FIG. 1) having the above composition is formed by vacuum evaporation.

Then, the phosphor layer 16 is subjected to a heat treatment (annealing) for imparting favorable photostimulated luminescence characteristics-thereto and improving the photostimulated luminescence characteristics thereof.

Next, an adhesive is applied onto the phosphor layer 16 using, for example, a dispenser.

After that, a moisture-proof protective film (not shown) being wound up into a roll is pulled out and then attached onto the phosphor layer 16 by thermal lamination, thereby forming the moisture-proof protective layer 18 (see FIG. 1).

The phosphor panel 10 can be thus fabricated.

The moisture-proof protective layer 18 may also be formed using a protective film to which an adhesive has been previously applied.

In the method of manufacturing the phosphor panel 10 of the present invention, a reflective film, a barrier film, or the like may be formed prior to forming the oxide layer 14 as described above. Alternatively, the substrate used may be the one on which the reflective film or the barrier was previously formed.

Prior to the sealing of the phosphor layer 16 with the moisture-proof protective layer 18, the phosphor layer 16 is preferably heated to a temperature ranging from a temperature 30° C. lower than the softening temperature of the adhesive to 150° C. such that the adhesion strength between the moisture-proof protective layer 18 and the substrate 12 can be improved when they are adhered to each other with a sealing/adhesive layer (not shown) and satisfactory adhesion strength is achieved by only one thermal lamination procedure. The temperature can be made to fall within the above range for example by heating the substrate 12.

The radiographic image conversion panel and the method of manufacturing the same according to the present invention have been described above. However, the present invention is by no means limited to the foregoing cases and various improvements and modifications may of course be made without departing from the scope and spirit of the invention.

### EXAMPLES

Hereinafter, the present invention will be described in greater detail with reference to specific examples. Needless to say, the present invention is not limited to the following examples.

In Examples, radiographic image conversion panels in Examples 1 to 20 and Comparative Examples 1 and 2, as well as a reference radiographic image conversion panel as shown in Table 1 below were fabricated and then evaluated for their images under the conditions described below.

In Examples, the phosphor panel 10 shown in FIG. 1 was not provided with the moisture-proof protective layer 18 to form the radiographic image conversion panel in each of Examples 1 to 20. The phosphor panel 10 shown in FIG. 1 was not provided with the oxide layer 14 and the moisture-proof protective layer 18 to form the radiographic image conversion panel in each of Comparative Examples 1 and 2.

Three kinds of aluminum substrates (flat rolled products, manufactured by Sumitomo Light Metal Industries, Ltd.) having different surface profiles as described below were used for the substrates of the radiographic image conversion panels in Examples 1 to 20 and Comparative Examples 1 and 2. Each of the aluminum substrates had a purity of 95% by weight and a size of 200 mm×200 mm.

The first kind of substrate used was 1 mm in thickness and had a comparatively rough surface (MF: 0.196 μm in arithmetic mean roughness Rₐ). The second kind of substrate used was 1 mm in thickness and had the surface smoothed by subjecting an original substrate having a comparatively smooth surface (SL: 0.074 μm in arithmetic mean roughness Rₐ) to electrolytic grinding (SL electrolytic grinding: 0.048 μm in arithmetic mean roughness Rₐ). The third kind of substrate used was obtained by subjecting an aluminum substrate having a thickness of 10 mm to lapping (flat rolled product polished by lapping: 0.083 μm in arithmetic mean roughness Rₐ). Thus, only the third kind of substrate had a thickness of 10 mm.

Next, the method of manufacturing each of the phosphor panels in Examples 1 to 20 shown in Table 1 below will be described.

At first, the respective substrates were degreased with a weakly alkaline cleaning solution containing a surfactant and then rinsed with deionized water, followed by drying.

As shown in Table 1, subsequently, oxide layers made of SiO₂ or Al₂O₃ were formed on the surfaces of the substrates by sputtering, ion plating, or ion beam assisted deposition so that they could have different thicknesses A (see FIG. 1). Since the film deposition rate was previously determined, the time required for the film deposition was adjusted to form the oxide layers having predetermined thicknesses A.

In Examples, the sputtering technique used was radio frequency (RF) sputtering. In addition, the sputtering target used was an oxide having substantially the same composition as that of SiO₂ or Al₂O₃ shown in Table 1 below. For coping with oxygen vacancy due to sputtering, the sputtering target had a higher oxygen content and was elongated in one direction. Besides, argon gas was used for the introduction gas and the pressure (degree of vacuum) inside a chamber was 0.5 Pa.

In Examples, film deposition was carried out by sputtering at a rate of 2 nm/second and each substrate was moved so as to intersect the longitudinal direction of the sputtering target during the formation of the oxide layer. Thus, the resulting oxide layer had a uniform thickness.

For ion plating, a film deposition (evaporation) chamber equipped with a plasma chamber was used. An EB evaporation hearth is provided in the lower part inside the film deposition chamber. A substrate holder is rotatably mounted at a position opposed to the EB evaporation hearth.

In the film deposition chamber, the oxide (film-forming material) having substantially the same composition as that of SiO₂ or Al₂O₃ shown in Table 1 was evaporated by an electron beam (EB) system using an electron gun. Argon gas was used for the introduction gas and the pressure (degree of vacuum) inside the plasma chamber was 0.1 Pa. Furthermore, the pressure (degree of vacuum) inside the film deposition chamber was 0.01 Pa or less.

In order to form the oxide layer, argon plasma was generated in the plasma chamber and the vicinity of the evaporation flow of the oxide in the deposition chamber was then irradiated with the argon plasma generated. Accordingly, the energy of particles evaporated from the oxide can be raised and the resulting oxide layer can have enhanced compactness and adhesiveness. Ion plating was carried out at a film deposition rate of 2 nm/second and each substrate was rotated on the substrate holder during the formation of the oxide layer. Thus, the resulting oxide layer had a uniform thickness.

In addition, for ion beam assisted deposition, a film deposition (evaporation) chamber equipped with a plasma chamber was used. An EB evaporation hearth and an ion gun are provided in the lower part inside the film deposition chamber. A substrate holder is rotatably mounted at a position opposed to the EB evaporation hearth. The ion gun is used to irradiate the substrate mounted on the substrate holder with plasma generated in the plasma chamber as gas ions.

According to the ion beam assisted deposition, the oxide (film-forming material) having substantially the same composition as that of SiO₂ shown in Table 1 was evaporated in the film deposition chamber by an EB system using an electron gun. Argon gas was used for the introduction gas and the pressure (degree of vacuum) inside the plasma chamber was 0.1 Pa. Furthermore, the pressure (degree of vacuum) inside the film deposition chamber was 0.01 Pa or less.

In order to form the oxide layer, argon plasma was generated in the plasma chamber and the substrate in the film deposition chamber was irradiated with Ar⁺ ions by the ion gun.

In ion beam assisted deposition, the kinetic energy of the Ar⁺ ions enhances the compactness and adhesiveness of the oxide layer formed. Ion beam assisted deposition was carried out at a film deposition rate of 0.8 nm/second and each substrate was rotated on the substrate holder during the formation of the oxide layer. Thus, the resulting oxide layer had a uniform thickness.

Next, the process of forming the phosphor layer will be described.

At first, a vacuum evaporation apparatus that is an apparatus for forming the phosphor layer will be described. In Examples, the apparatus used for forming the phosphor layer was different from that for forming the oxide layer. More specifically, a vacuum evaporation apparatus as shown in FIG. 2 in which vacuum evaporation was carried out while a substrate P was linearly transported in a transport direction was used in Examples.

The vacuum evaporation apparatus has a heat-evaporation unit 100 in the lower part inside a vacuum chamber (not shown). The vacuum evaporation apparatus used in Examples carries out two-source vacuum evaporation in which cesium bromide (CsBr) and europium bromide (EuBr₂) used as film-forming materials are separately evaporated. Therefore, the heat-evaporation unit 100 has europium evaporators (hereinafter referred to as Eu evaporators) 102b and cesium evaporators (hereinafter referred to as Cr evaporators) 102a.

The heat-evaporation unit 100 includes six Cs evaporators 102a and six Eu evaporators 102b which are arranged in a direction perpendicular to the direction in which the substrate P is transported. In addition, above the heat-evaporation unit 100, shutters (not shown) are provided for the Cs evaporators 102a and Eu evaporators 102b, respectively.

The Eu evaporators 102b have a function of evaporating europium bromide (an activator material) contained in evaporation sites (crucibles) by means of resistance heating with a resistance-heating apparatus (not shown).

In addition, the Cs evaporators 102a have a function of evaporating cesium bromide (host crystal material) contained in evaporation sites (crucibles) by means of resistance heating with a resistance-heating apparatus (not shown).

Furthermore, the vacuum chamber includes the substrate holder (not shown) for holding the substrate P. The substrate holder is attached to a transporting mechanism which is capable of linearly transporting the substrate P in the direction of transport (i.e., the direction perpendicular to the direction along which the crucibles are arranged). Therefore, the substrate P can be linearly transported multiple times in a to-and-fro manner. Furthermore, a vacuum pumping system is connected to the vacuum chamber. The phosphor layer was formed using the vacuum evaporation apparatus configured as described above.

Next, the process of forming the phosphor layer will be described.

For each of Examples, cesium bromide (CsBr) powder with a purity of not less than 4N and a molten product of europium bromide (EuBr₂) with a purity of not less than 3N were prepared as evaporation sources. Here, the process of preparing the EuBr₂ molten product will be explained. At first, EuBr₂ powder was placed in a platinum crucible in a tube furnace under a sufficient halogen atmosphere to prevent oxidation. Then, the platinum crucible was heated to 800° C. to melt the EuBr₂ powder. Subsequently, the platinum crucible was cooled and then taken out from the furnace, thereby obtaining the EuBr₂ molten product. The trace elements in the respective raw materials were analyzed by inductively coupled plasma-mass spectrometry (ICP-MS). As a result, the contents of alkaline metals (Li, Na, K, and Rb) in CsBr except Cs were 10 ppm by weight or less, respectively. The contents of other elements such as alkaline earth metals (Mg, Ca, Sr, and Ba) were 2 ppm by weight or less, respectively. The contents of rare earth elements in EuBr₂ except Eu were 20 ppm by weight or less, respectively. Furthermore, the contents of the other elements were 10 ppm by weight or less, respectively. Those raw materials had high moisture absorption. Thus, the materials were stored in a desiccator kept in a dry atmosphere having a dew point of −20° C. or lower and then taken out just before use.

The substrate P on which the oxide layer was formed was first placed on the substrate holder in the vacuum evaporation apparatus to form the phosphor layer. The distance between the substrate P and the heat-evaporation unit 100 was 15 cm.

Each crucible for resistance heating in the apparatus was filled with a CsBr or EuBr₂ evaporation source and a main exhaust valve was opened to evacuate the apparatus, thereby attaining a degree of vacuum of 1×10⁻³ Pa.

For this operation, a combination of rotary pump, mechanical booster and diffusion pump was used for the vacuum pumping system. Furthermore, for moisture removal, a cryogenic pump for removing moisture was employed. After that, the evacuation mode was switched from the main exhaust valve to a bypass. Subsequently, argon gas was introduced in the apparatus, thereby attaining a degree of vacuum of 0.5 Pa. The surface of the oxide layer was washed by argon plasma generated in a plasma generator (ion gun).

Afterwards, the evacuation mode was switched to the main exhaust valve to evacuate to a degree of vacuum of 1×10⁻³ Pa. The evacuation mode was switched to the bypass again, and argon gas was introduced to attain a degree of vacuum of 1 Pa.

While the shutters provided between the substrate P and the heat-evaporation unit 100 (Cs evaporators 102a and Eu evaporators 102b) were being closed, each of the evaporation sources (CsBr and EuBr₂) was heated and molten by the resistance-heating apparatus. After that, only the shutter on the side of Cs evaporators 102a was opened and the host material of CsBr phosphor was deposited onto the surface of the substrate P.

Next, 3 minutes after the shutter had been opened, the shutter on the side of the Eu evaporators 102b was also opened, and the CsBr:Eu stimulable phosphor was deposited onto the host material of CsBr phosphor.

At this time, the substrate P was periodically transferred linearly at a transport rate of 200 mm/second to make the thickness of the phosphor layer formed uniform.

The film deposition rate was set at 8 μm/minute. In addition, the resistance current of each resistance-heating apparatus in the heat-evaporation unit 100 was adjusted so that the molarity ratio of Eu/Cs in the stimulable phosphor layer could reach 0.001/l.

After the deposition, the pressure inside the apparatus was adjusted to atmospheric pressure and the substrate was then taken out from the apparatus. Subsequently, the substrate was placed in a heat-treating furnace. The inside of the heat-treating furnace was placed under the atmosphere of nitrogen gas, followed by heating at 200° C. for 2 hours.

Thus, a phosphor layer having the structure in which columnar crystals of a phosphor were densely formed in a substantially vertical direction was formed on the oxide layer of the substrate. The phosphor layer had a thickness C of 600 μm and the surface area of the phosphor layer formed was 200 mm×200 mm.

In this way, the radiographic image conversion panels of Examples 1 to 20, each of which was formed of the substrate, the oxide layer, and the phosphor layer, were prepared by co-deposition. In Comparative Examples 1 and 2, no oxide layer was formed but the phosphor layer was directly formed on the surface of the substrate.

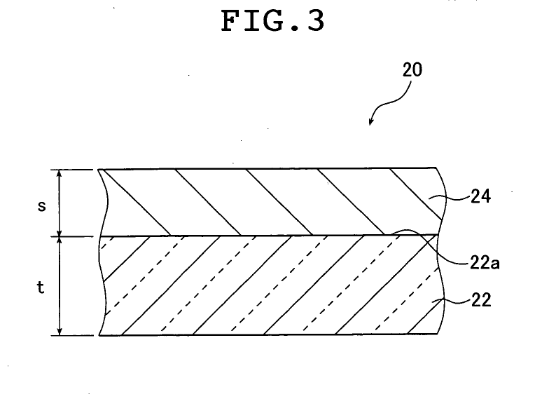

In addition, a radiographic image conversion panel 20 (hereinafter referred to as a reference panel) having a glass substrate 22 and a phosphor layer 24 formed on a surface 22a of the glass substrate 22 as shown in FIG. 3 was prepared as the reference for the evaluation. The phosphor layer 24 of the reference panel 20 was prepared as in Examples 1 to 20. The phosphor layer 24 had a thickness s of 600 μm. No moisture-proof protective layer was formed on the reference panel 20.

The glass substrate 22 used was “Eagle 2000 (trade name)”, manufactured by Corning Incorporated. The glass substrate 22 was 0.63 mm in thickness t and 200 mm×200 mm in size.

The surface roughness of the substrate was determined as follows. At first, the surface profile of each of the three kinds of substrates was observed using a 3D profile microscope (VK-8550, manufactured by Keyence Corporation) capable of producing deep depth of focus images, thereby obtaining data about the surface profiles of the three kinds of substrates. The conditions for measuring the surface roughness included a pitch of 0.01 μm for height measurement (i.e., measuring resolution) and a measuring area of 100 μm².

Subsequently, on the basis of the data on the surface profile of each substrate, the arithmetic mean roughness Rₐ was determined using image measurement/analysis software (VK-H1A7). The arithmetic mean roughness Rₐ was calculated according to JIS B 0601-1994.

In Examples, each radiographic image conversion panel thus prepared was evaluated by the evaluation method of the “deterioration of the phosphor layer/substrate due to humidity”. Now, the term “deterioration of the phosphor layer/substrate due to humidity” will be explained.

At first, before exposure to constant temperature and humidity environment, the surface of each of the radiographic image conversion panels was irradiated with X-rays having a tube voltage of 80 kVp using a tungsten lamp, at a dose of 10 mR (2.58×10⁻⁶ C/kg). After that, the radiographic image conversion panel was irradiated with semiconductor laser beams of 660 nm in wavelength having excitation energy of 5 J/m², and photostimulated luminescence emitted from the surface of the radiographic image conversion panel was received on an optical receiver (photomultiplier with spectral sensitivity S-5). Then, the received light was converted into electric signals, which were then converted into digital signals. An image reproducing apparatus which forms digital signals into image was used to obtain an image, which was then read and output as a visible image on a film by a laser printer.

Next, each of the radiographic image conversion panels thus prepared was left standing in a thermostatic chamber at a temperature of 32° C. and a relative humidity of 80% for 24 hours. After that, each panel was taken out from the thermostatic chamber and the same conditions and method as those used to obtain the above image were applied to obtain an image deteriorated due to humidity. The image thus obtained was output as a visible image on a film by a laser printer.

Each phosphor panel was evaluated for the change between the images before and after the test. Each radiographic image conversion panel was visually compared with the reference panel and evaluated for the image quality on a scale of A to E. The results are shown in Table 1.

The graininess of the reference panel was slightly changed by the deterioration of the phosphor layer due to humidity.

Criteria for evaluation were as follows. The case where the change in graininess between the images before and after the test of a panel was substantially the same as that found in the reference panel was defined as “A”. The case where the change of the graininess in a tested panel was slightly larger than that in the reference panel under careful observation was defined as “B”. The case where the change of graininess in a tested panel was clearly larger than that in the reference panel was defined as “C”. The case where the change of graininess in a tested panel was greatly larger than that in the reference panel but no artifact having a long period of 1 mm or more was observed was defined as “D”. The case where the change of graininess in a tested panel was definite and the resulting image had artifacts and hence was not appropriate for medical use was defined as “E”.

In Examples, a glass substrate that would not corrode was used for the substrate of the reference panel and the same phosphor layer was formed on every substrate. Thus, the influence of corrosion of the substrate on each panel can be investigated.

TABLE 1

| | | | | | | Deterioration of |
|---|---|---|---|---|---|---|
| | | Surface | Oxide layer | | | phosphor layer/ |
| | | roughness | Film-forming | | Thickness | substrate due to |
| | Type of Substrate | (μm) | method | Material | (μm) | humidity |
| Reference | Glass substrate | — | — | — | — | — |
| Comparative | MF | 0.196 | — | — | — | E |
| Example 1 | | | | | | |
| Comparative | SL-electrolytic grinding | 0.048 | — | — | — | E |
| Example 2 | | | | | | |
| Example 1 | SL-electrolytic grinding | 0.048 | Sputtering | SiO₂ | 0.1 | D |
| Example 2 | SL-electrolytic grinding | 0.048 | Ion plating | Al₂O₃ | 0.1 | D |
| Example 3 | SL-electrolytic grinding | 0.048 | Ion plating | Al₂O₃ | 0.3 | D |
| Example 4 | SL-electrolytic grinding | 0.048 | Sputtering | SiO₂ | 1.0 | C |
| Example 5 | SL-electrolytic grinding | 0.048 | Sputtering | SiO₂ | 3.0 | B |
| Example 6 | SL-electrolytic grinding | 0.048 | Sputtering | Al₂O₃ | 1.0 | C |
| Example 7 | SL-electrolytic grinding | 0.048 | Sputtering | Al₂O₃ | 3.0 | A |
| Example 8 | MF | 0.196 | Ion plating | SiO₂ | 1.0 | C |
| Example 9 | MF | 0.196 | Ion plating | SiO₂ | 3.0 | B |
| Example 10 | SL-electrolytic grinding | 0.048 | Ion plating | SiO₂ | 1.0 | C |
| Example 11 | SL-electrolytic grinding | 0.048 | Ion plating | SiO₂ | 3.0 | A |
| Example 12 | MF | 0.196 | Ion plating | Al₂O₃ | 1.0 | C |
| Example 13 | MF | 0.196 | Ion plating | Al₂O₃ | 3.0 | B |
| Example 14 | SL-electrolytic grinding | 0.048 | Ion plating | Al₂O₃ | 1.0 | B |
| Example 15 | SL-electrolytic grinding | 0.048 | Ion plating | Al₂O₃ | 3.0 | A |
| Example 16 | SL-electrolytic grinding | 0.048 | Ion plating | Al₂O₃ | 8.0 | A |
| Example 17 | Rolling and lapping | 0.083 | Ion plating | Al₂O₃ | 1.0 | B |
| Example 18 | Rolling and lapping | 0.083 | Ion plating | Al₂O₃ | 3.0 | A |
| Example 19 | Rolling and lapping | 0.083 | Ion beam | SiO₂ | 1.0 | C |
| | | | assisted deposition | | | |
| Example 20 | Rolling and lapping | 0.083 | Ion beam | SiO₂ | 3.0 | A |
| | | | assisted deposition | | | |

As shown in Table 1 above, sufficient image quality for use as a medical image was achieved in each of Examples 1 to 20.

Examples 1 to 3 were ranked low because the thickness of the oxide layer was less than 0.5 μm which was outside the preferable range. Examples 4 to 20 in which the oxide layers each had a thickness of not less than 0.5 μm which was within the preferable range were ranked relatively high.

In Examples 4 to 20, when the substrates showed the same surface roughness, the thicker the oxide layer was, the higher the panel was ranked. In addition, in Examples 4 to 20, when the oxide layers were made of the same material, there was a tendency for a thicker oxide layer to be ranked higher.

There was also a tendency for Examples 10, 11 and 14 to 20 in which the surface roughness of each substrate was in a preferable range (the arithmetic mean roughness Rₐ was in the range of 0.05 to 0.1 μm) to be ranked higher than Examples 8, 9, 12, and 13 in which the surface roughness of each substrate exceeded the preferable range.

On the other hand, Comparative Examples 1 and 2 in which no oxide layers were formed were ranked on a scale of “E” in the evaluation of the deterioration of the phosphor layer/substrate due to humidity, which showed that sufficient image quality for use as a medical image was not obtained in Comparative Examples.

What is claimed is:

1. A radiographic image conversion panel comprising:
a substrate made of a metal or an alloy;
an oxide layer formed on the substrate by a vapor deposition technique; and
a phosphor layer formed on the oxide layer by the vapor deposition technique.

2. The radiographic image conversion panel according to claim 1, wherein the oxide layer is formed by sputtering, ion plating or ion beam assisted deposition.

3. The radiographic image conversion panel according to claim 1, wherein the oxide layer is made of SiO₂, Al₂O₃, or TiO₂.

4. The radiographic image conversion panel according to claim 1, wherein the oxide layer has a thickness of 0.5 μm or more.

5. The radiographic image conversion panel according to claim 1, wherein a surface of the substrate has an arithmetic mean roughness Rₐ of 0.005 to 0.1 μm.

6. The radiographic image conversion panel according to claim 1, wherein a surface of the substrate has a maximum height R_{y} of 0.005 to 1 μm.

7. The radiographic image conversion panel according to claim 1, wherein the substrate is made of aluminum.

8. The radiographic image conversion panel according to claim 1, wherein the phosphor layer is made of CsBr:Eu.

9. A method of manufacturing a radiographic image conversion panel, comprising the steps of:
forming an oxide layer on a substrate made of a metal or an alloy by a vapor deposition technique; and
forming a phosphor layer on the oxide layer by the vapor deposition technique.
